(19) United States
(12) Patent Application Publication
(10) Pub. No.: US 2009/0089386 A1
(43) Pub. Date: Apr. 2, 2009

(54) Method of communicating e-mail and apparatus using the same

(75) Inventors: Ji-hyun Goh, Changwon-city (KR); Sung-cheol Bae, Changwon-city (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 12/221,246

(22) Filed: Jul. 31, 2008

(30) Foreign Application Priority Data
Sep. 28, 2007 (KR) 10-2007-0098388
Mar. 21, 2008 (KR) 10-2008-0026317

(51) Int. Cl. G06F 15/16

(52) U.S. Cl. 709/206

(57) ABSTRACT

Provided are a method of communicating an e-mail and an apparatus using the same. The method includes: selecting at least one image file; generating an index file including an index image of the at least one image file; and generating an e-mail including the at least one image file and the index file. Accordingly, the image file can be checked by simply checking the index file having a relatively small size. In addition, desired image files can be selectively downloaded.

### CROSS-REFERENCE TO RELATED PATENT APPLICATIONS

This application claims the benefit of Korean Patent Application Nos. 10-2007-0098388 and 10-2008-0026317, filed on Sep. 28, 2007 and Mar. 21, 2008, respectively, in the Korean Intellectual Property Office, the entire contents of which are incorporated herein by reference.

### BACKGROUND OF THE INVENTION

1. Field of the Invention

The present invention relates to a method of communicating an e-mail to which an image file is attached, and a communication apparatus using the method.

2. Description of the Related Art

Conventionally, when a transmitter transmits an e-mail to which an image file is attached, and a receiver checks the e-mail, the receiver can check the image file only if the image file is downloaded and opened. Since only a name of an attachment of the e-mail is simply described, an image file has to be downloaded so as to be opened in order to check an image of an image file. At this time, when the image file has a relatively large size, it takes a long time to download each image file and check it. In addition, the more the number of image files, the harder it is to download each of image files.

### SUMMARY OF THE INVENTION

The present invention provides a method of communicating an e-mail in which an attached image file can be easily downloaded and the image file can be easily checked, and a communication apparatus using the method.

According to an embodiment of the present invention, there is provided a method of communicating an e-mail, the method including: selecting at least one image file; generating an index file including an index image of the at least one image file; and generating an e-mail including the at least one image file and the index file.

A size of an original image of the at least one image file may be reduced so as to generate an index image. A thumbnail image of the image file may be extracted so that the thumbnail image is used as an index image.

The image file may be a still image file or a moving picture file including a plurality of frame images.

When the image file is a moving picture file, an index image may be generated by reducing a size of any one frame image selected from among the frame images or by using a thumbnail image of the moving picture file as the index image.

According to the method of communicating an e-mail, the size of the index file can be adjusted according to the number of attached image files. When the number of attached image files is relatively great, the index file can be divided into at least two according to the maximum size of the image file. In addition, when the number of attached image files is relatively small, the region of the index file, in which the index image and its file name are stored, can be reduced.

The e-mail may be generated by attaching the index file to the e-mail or inserting the index file into an e-mail text.

The method may further include detecting that the e-mail includes the index file.

The method may further include displaying the index file when it is detected that the e-mail includes the index file.

The e-mail text may be displayed on a main-window, and the index file may be displayed on a sub-window.

According to another embodiment of the present invention, there is provided an e-mail communication apparatus including: an index file generating unit generating an index file from at least one selected image file; and an e-mail generating unit generating an e-mail including the index file.

The index file generating unit may include an index image generating unit generating an index image by reducing a size of an original image of the image file or generating the index image by using a thumbnail image of the image file as the index image.

When the image file is a moving picture file including a plurality of frame images, the index image generating unit generates an index image by reducing a size of any one frame image selected from among the frame images or generating the index image by using a thumbnail image of the moving picture file as the index image.

The index file generating unit may include a filename combining unit combining the index image with a filename of a corresponding image file.

The index file generating unit may include a size adjusting unit adjusting a size of an index file according to the number of attached image files. The e-mail generating unit may generate an e-mail by attaching the index file or inserting the index file into an e-mail text.

The apparatus may further include an index file detection unit detecting that the e-mail includes the index file.

The apparatus may further include a display controlling unit controlling the index file detected by the index file to be displayed in an e-mail receiving terminal.

The e-mail communication apparatus may include: an e-mail server writing an e-mail including the image file and the index file; an e-mail transmitting terminal transmitting the e-mail; and an e-mail receiving terminal receiving the e-mail.

The e-mail transmitting terminal or the e-mail server may include the index file generating unit.

### BRIEF DESCRIPTION OF THE DRAWINGS

The above and other features and advantages of the present invention will become more apparent by describing in detail exemplary embodiments thereof with reference to the attached drawings in which:

FIG. 1 is a view illustrating an example of an e-mail communication system according to an embodiment of the present invention;

FIG. 2 is a block diagram illustrating an example of an e-mail communication apparatus according to an embodiment of the present invention;

FIG. 3 is a block diagram illustrating an example of an index file generating unit of the e-mail communication apparatus of FIG. 2, according to an embodiment of the present invention;

FIG. 4 is a flowchart illustrating an example of a method of communicating an e-mail according to an embodiment of the present invention;

FIGS. 5 through 8 illustrate an example of an operation of generating an index file, according to an embodiment of the present invention;

FIGS. 9 through 11 illustrate an example of an operation of generating an e-mail, according to an embodiment of the present invention;

FIG. 12 is a flowchart illustrating an example of a method of communicating an e-mail according to another embodiment of the present invention;

FIGS. 13 through 15 illustrate an example of an operation of adjusting the size of an index file, according to an embodiment of the present invention;

FIG. 16 is a flowchart illustrating an example of an operation of detecting and displaying an index file, which is performed in a method of communicating an e-mail according to another embodiment of the present invention;

FIG. 17 illustrates an example of an operation of detecting and displaying an index file in an e-mail receiving terminal, according to an embodiment of the present invention;

FIGS. 18 and 19 illustrates an example of an operation of displaying an e-mail that is received from an e-mail receiving terminal, according to an embodiment of the present invention.

### DETAILED DESCRIPTION OF THE INVENTION

Exemplary embodiments of the present invention will now be described in detail with reference to the attached drawings.

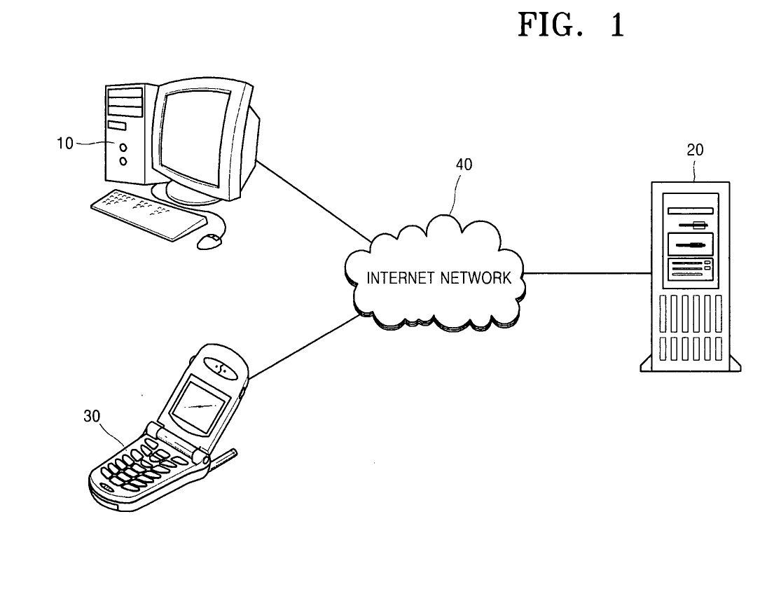

FIG. 1 illustrates an example of a network of an e-mail communication apparatus according to an embodiment of the present invention.

The e-mail communication apparatus includes an e-mail transmitting terminal, an e-mail receiving terminal and an e-mail server 20. In the current embodiment, a personal computer (PC) 10 and a mobile phone (cellular phone) 30 are respectively illustrated as an e-mail transmitting terminal and an e-mail receiving terminal, but the present invention is not limited thereto. That is, a mobile apparatus (e.g., a cellular phone, a personal digital computer (PDA), or the like) may be used as the e-mail transmitting terminal, and a PC or the like may also be used as the e-mail receiving terminal.

In particular, the personal computer 10 provides an image file, and forms an e-mail to which the image file is attached so as to transmit the e-mail to the mobile phone 30.

The e-mail server 20 may provide a function of generating an index file of the image file, a function of generating an e-mail to which the index file is attached, a function of detecting the index file to automatically display the index file, etc. when transmitting an e-mail to which the image file is attached. In addition, the e-mail server 20 may support various functions such as an e-mail security authentication function, a schedule management function, an automatic response function, etc.

The personal computer 10, the e-mail server 20 and the mobile phone 30 may each transmit an e-mail via an Internet network 40.

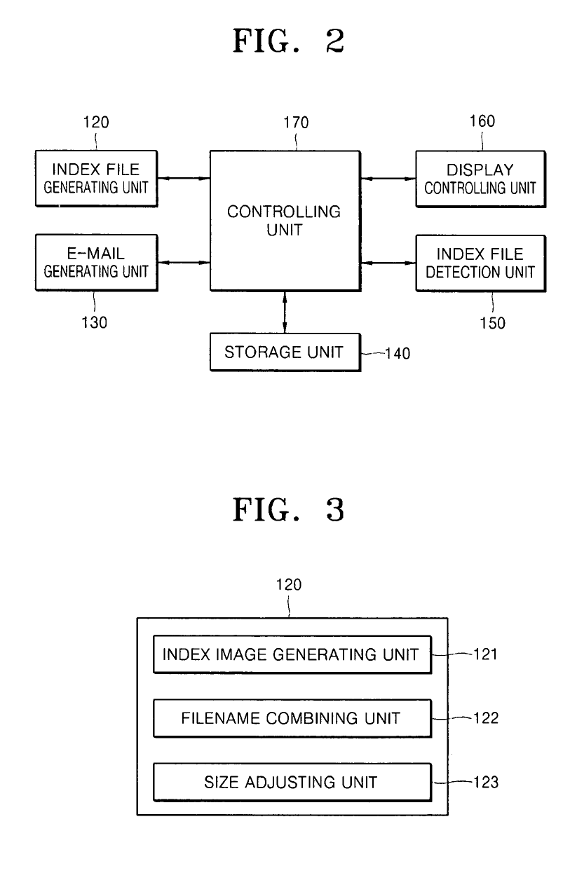

FIG. 2 is a block diagram illustrating an example of an e-mail communication apparatus, according to an embodiment of the present invention. FIG. 3 is a block diagram illustrating an example of an index file generating unit 120 of the e-mail communication apparatus of FIG. 2, according to an embodiment of the present invention.

The e-mail communication apparatus may include the index file generating unit 120, an e-mail generating unit 130, a storage unit 140, an index file detection unit 150, a display controlling unit 160 and a controlling unit 170.

The index file generating unit 120 generates an index image by using an image file to be attached, and combines the index image and a name of the image file to generate the index file. In particular, referring to FIGS. 2 and 3, the index file generating unit 120 selects a thumbnail image to use the thumbnail image as an index file when the thumbnail image is previously included in the image file. Alternatively, the index file generating unit 120 may include an index image generating unit 121 generating an index file by reducing a size of an original image of the image file.

In addition, the index file generating unit 120 may include a filename combining unit 122 storing the index image together with a filename of a corresponding image file.

The index file generating unit 120 may include a size adjusting unit 123 that compares the size of stored index image and filename with the maximum size of index file and adjusts the size of index file so as to change the size of index file or generate at least two index files according to the maximum size.

The index file generating unit 120 may be included in an e-mail server, or alternatively, may be included in an e-mail transmitting terminal. For example, in the first case, the e-mail server may receive a first e-mail including an image file attached thereto from the e-mail transmitting terminal, may generate an index file from the image file to form a second e-mail further including the index file, and may transmit the second e-mail to the e-mail receiving terminal. In the second case, the e-mail transmitting terminal may form an e-mail to which an image file and an index file generated from the attached image file are attached, and may transmit the e-mail to an e-mail receiving terminal via the e-mail server.

Referring back to FIG. 2, the e-mail generating unit 130 generates an e-mail including the index file that is provided from the index file generating unit 120. In particular, the e-mail generating unit 130 generates the e-mail including the image file and an index file of the image file, which are attached thereto, and a written text. Alternatively, the e-mail generating unit 130 may generate the e-mail so that the text of the e-mail includes the index file.

The e-mail generating unit 130 may be included in an e-mail server or an e-mail transmitting terminal. The e-mail generating unit 130 generates an e-mail including an index file, and thus may be included in the e-mail transmitting terminal when the e-mail transmitting terminal generates an index file. Likewise, the e-mail generating unit 130 may be included in the e-mail server when the e-mail server generates an index file.

According to embodiments of the present invention, an e-mail communication apparatus performs generating an index file, transmitting an e-mail to which the index file is attached, and checking the index file. Any server or terminal may generate an index file and generate an e-mail including the index file. However, it will be obvious to one of ordinary skill in the art that the present invention is not limited thereto so that the e-mail communication apparatus can perform the functions.

The e-mail communication apparatus includes the storage unit 140. The storage unit 140 stores programs required for operating the e-mail communication apparatus, temporally stores data, and the like required for embodying the programs, and stores information for recording data. In particular, the storage unit 140 may store a program used for generating an index file, a program used for an e-mail including the index file, and the like. Moreover, the storage unit 140 may temporally store data that is converted so as to embody the programs, an index image that is generated in order to generate an index file, a filename, and the like. In addition, the storage unit 140 may store an e-mail that is received or transmitted.

The e-mail transmitting terminal may generate an index file by downloading an index file generating program from the storage unit 140 and embodying the index file generating program. Alternatively, the e-mail server may include the storage unit 140, and thus the e-mail server may embody an index file generating program.

The index file detection unit 150 detects whether a received e-mail includes an index file. If there is an index file, the display controlling unit 160 may display information regarding that there is an index file, or alternatively, may control the index file to be automatically opened and displayed. Of course, the index file is controlled to be displayed on the e-mail receiving terminal. Thus, an e-mail receiver can check an attached image file by checking the index file via the information or checking the index file that is automatically displayed even though a desired image is not opened. In addition, only a desired image file is selectively downloaded, thereby reducing the time required to transmit an e-mail.

The display controlling unit 160 may control an e-mail text to be displayed on a main window, and may control an index file to be displayed on a sub-window. For example, when the index file detection unit 150 detects that an e-mail includes an index file, the display controlling unit 160 may automatically open the index file and then may display the index file on the sub-window.

The index file detection unit 150 and the display controlling unit 160 may each be included in the e-mail server or the e-mail receiving terminal.

Although not illustrated in drawings, the e-mail transmitting terminal may include an operating unit used for inputting a transmitter operating signal of writing an e-mail text or selecting an image file, and the e-mail receiving terminal may include a displaying unit displaying a transmitted e-mail and index file.

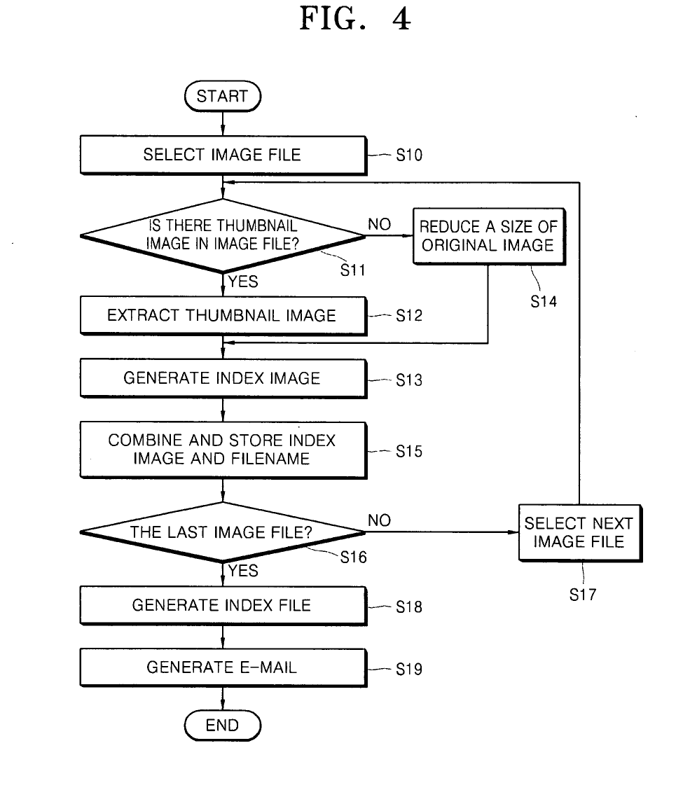

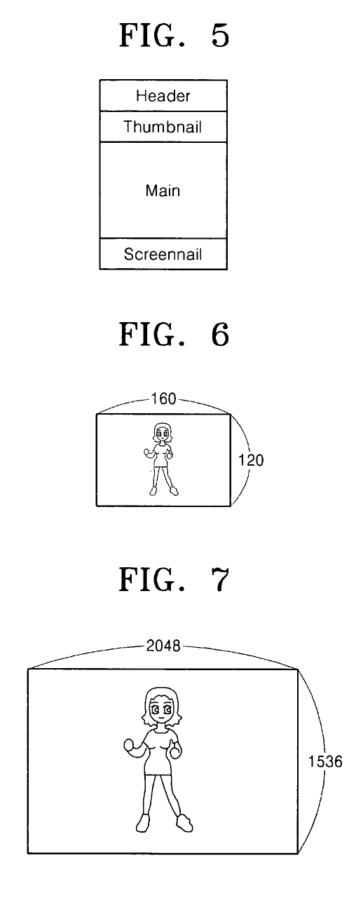

FIG. 4 is a flowchart illustrating an example of a method of communicating an e-mail according to an embodiment of the present invention. For convenience of description, the method will be described with reference to FIGS. 5 though 11.

Referring to FIG. 4, an image file to be attached is selected (operation S10).

The image file is analyzed and it is checked whether there is a thumbnail image (operation S11). Referring to FIG. 5, the image file includes a header region in which file information is stored, a Main region in which original image data is stored, and a Thumbnail region in which data of a thumbnail image which size is reduced from a size of the original image is stored. In addition, the image file may further include a Screennail region in which Screennail image data is stored, For example the Screennail image may be greater than the thumbnail image and smaller than the original image.

FIG. 6 illustrates an example of a thumbnail image, according to an embodiment of the present invention. For example, the thumbnail image may have a resolution of 160*120. On the other hand, FIG. 7 illustrates an example of an original image, according to an embodiment of the present invention. For example, the original image may have a resolution of 2048*1536.

Referring back to FIG. 4, if there is a thumbnail image in an image file, the thumbnail image is extracted (operation S12). The thumbnail image is used as an index image, thereby generating the index image (operation S13).

If there is not a thumbnail image in an image file, a size of an original image is reduced (operation S14). For example, when the original image has a size of 2048*1536, a size of the original image may be reduced to a size of 160*120, thereby generating the index image (operation S13).

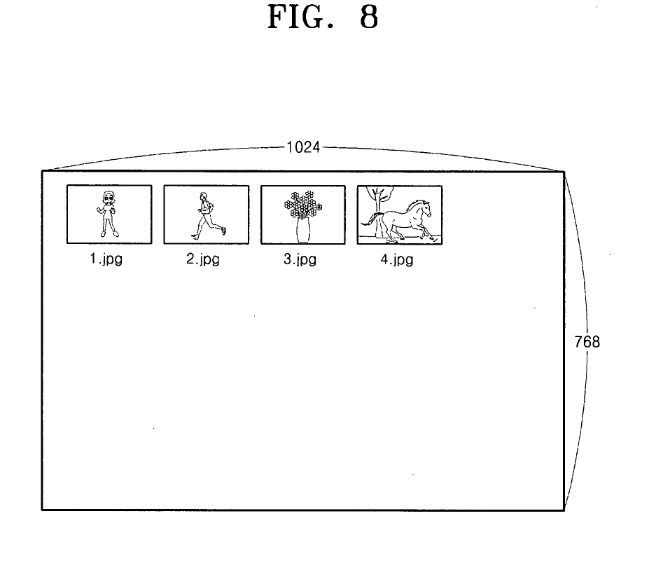

An image file name corresponding to the generated index image is stored (operation S15). For example, as illustrated in FIG. 8, index images together with their filenames 1.jpg, 2.jpg, 3.jpg and 4.jpg below respective index images are stored.

Referring back to FIG. 4, it is determined whether the image file generating the index file is the last file (operation S16).

If the image file is not the last file, a next image file is selected (operation S17), and it is checked whether there is a thumbnail image in the selected image file (operation S11). Then, these operations are repeated.

If the image file is the last file, an index file including the stored index image and a filename is generated (operation S18).

An e-mail including the index file is generated (operation S19).

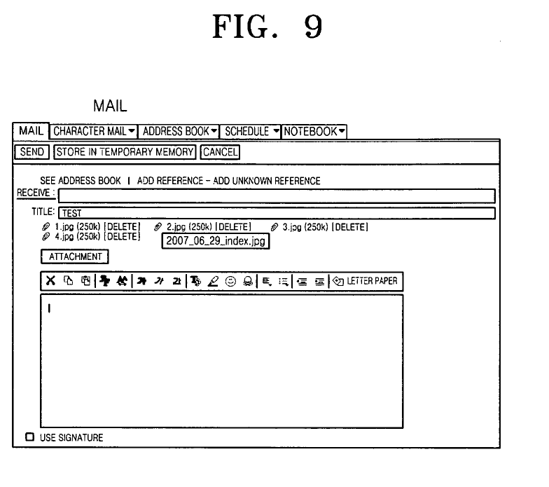

FIGS. 9 through 11 illustrate examples of screens on which an e-mail is written in an e-mail transmitting terminal.

Referring to FIG. 9, an address of a recipient, a title, a text, etc. are written in an e-mail terminal, and an image file is attached to an e-mail. Currently, four image files are attached, and a mode of generating index files of respective four image files is performed. Alternatively, when an index file is generated in an e-mail server, only information regarding that the index file will be generated may be indicated.

For example, index filename 2007_{—}06_{—}29_index.jpg may be displayed on a blank attachment of a screen of FIG. 9. In addition, an index file may be generated in the e-mail server. Thus, when an e-mail is written in the e-mail transmitting terminal, the index file cannot be opened so as to be checked.

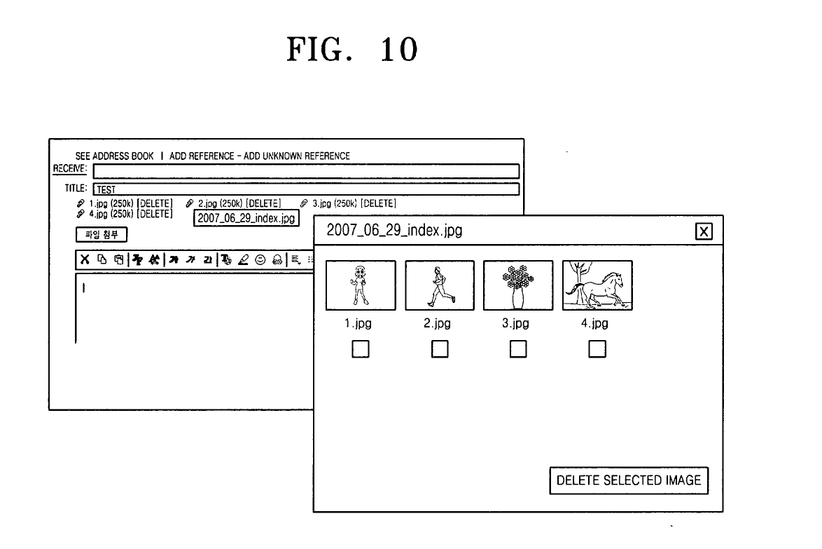

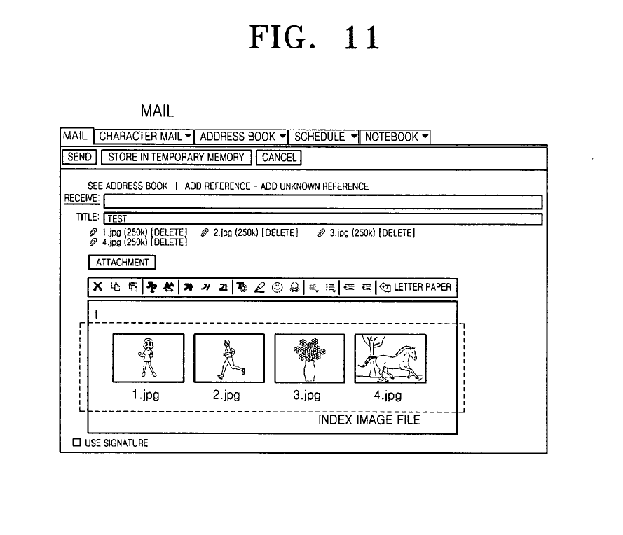

However, when an index file generating program is downloaded in the e-mail transmitting terminal, and an index file is generated in the e-mail transmitting terminal, the index file can be opened in the e-mail transmitting terminal. For example, referring to FIG. 10, the index file may be displayed so as to be checked in the e-mail transmitting terminal, and the attached image file may be deleted on a sub-window. Alternatively, referring to FIG. 11, an index file may be inserted into the e-mail text so as to be checked.

The generated e-mail is finally transmitted to the e-mail receiving terminal such that a recipient can check the e-mail. By checking the index file, the recipient can easily check an image and can selectively download only desired image file even though the image file, the capacity of which is relatively greater than that of the index file, is not downloaded.

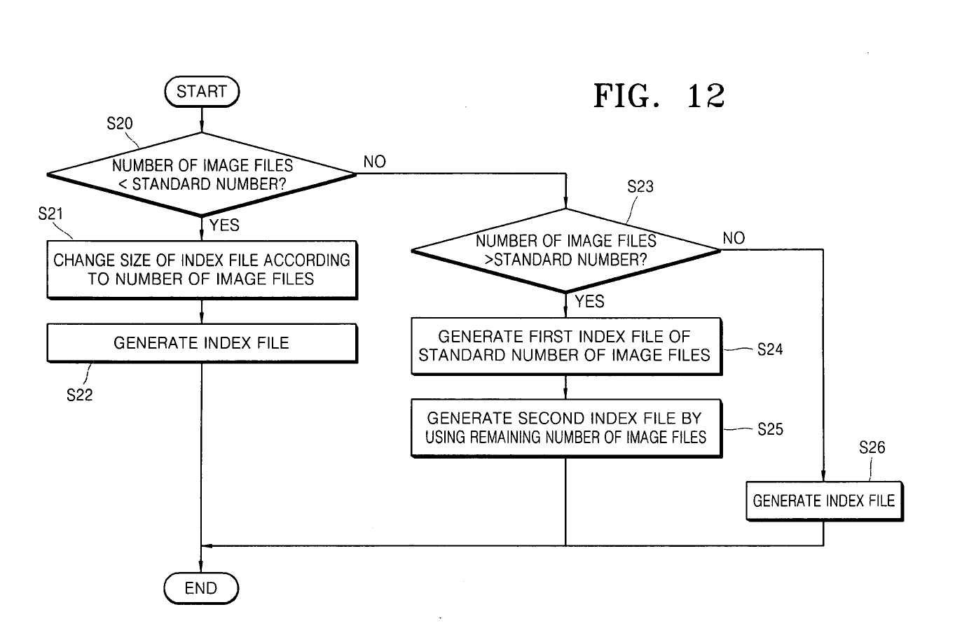

FIG. 12 is a flowchart illustrating an example of an operation of generating an index file, which is performed in a method of communicating an e-mail according to another embodiment of the present invention. In the current embodiment, the size of an index file may be changed according to the number of image files. Also, the operation according to the current embodiment will be described with reference to FIGS. 12 through 15.

First, it is determined whether the number of attached image files is smaller than a standard number that is the number of images files constituting an index file (operation S20). For example, when the maximum size of an index file is predetermined, and the index file can maximally include index images of 20 image files, the standard number is 20.

As a result, when the number of image files is smaller than the standard number, the size of index file is changed according to the number of image files (operation S21). In addition, the index file is generated (operation S22).

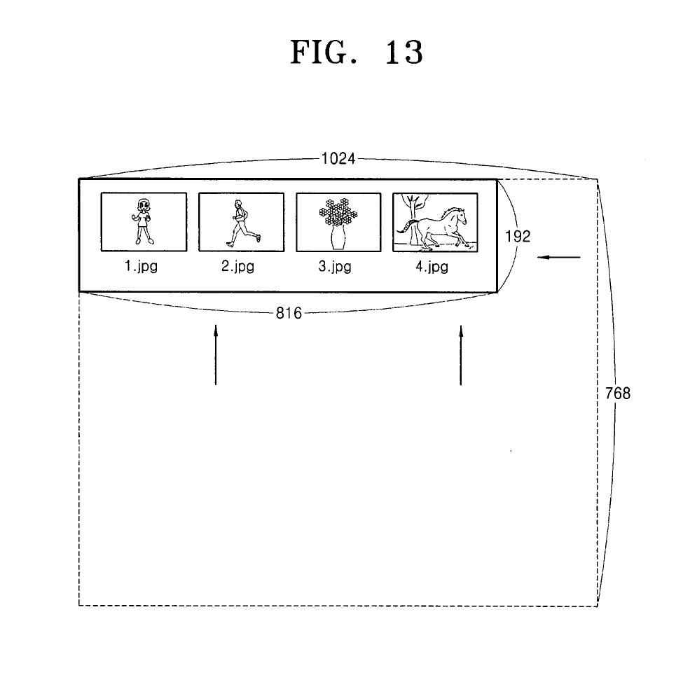

Referring to the example illustrated in FIG. 13, four image files are currently attached, and index images of respective attached image files are formed, thereby forming an index file. However, since the number of index images constituting one index file, that is, the number of standard number is 20, the number of image files that are currently attached is smaller than the standard number. Thus, the size of index file can be changed according to the number of attached image files.

As an example of a method of adjusting the size of index file, when an index image has a resolution of 160*120, and the predetermined size of index file is 1024*768, the number of index images constituting the index file may be 5*4. Of course, the number of index images may be changed according to the size of blank space. When the standard number is predetermined as 20, four index images are stored, the size of storage region may be 816*192 including the size of blank space. Thus, when four image files are attached, an index file has a resolution of 816*192 such that the size of index file can be adjusted.

Referring back to FIG. 12, when the number of attached image files is not smaller than the standard number, it is checked whether the number of image files is greater than the standard number (operation S23). The order of operations S20 and S23 may be reversed. That is, the present invention is not limited as to the specific order in this regard.

When the number of image files is greater the standard number, a first index file is generated with respect to the standard number of image files (operation S24). In addition, a second index file is generated with respect to the remaining number of image files (operation S25). With regard to the second index file, if the remaining number of image files is greater than the standard number, the second index file is generated with respect to the standard number of image files, and then a third index file is generated with respect to the other remaining number of image files. Alternatively, when the remaining number is the same as the standard number, the second index file is generated with respect to the remaining number of image files. When the remaining number is smaller than the standard number, the second index file including index images of the remaining number of image files may be generated.

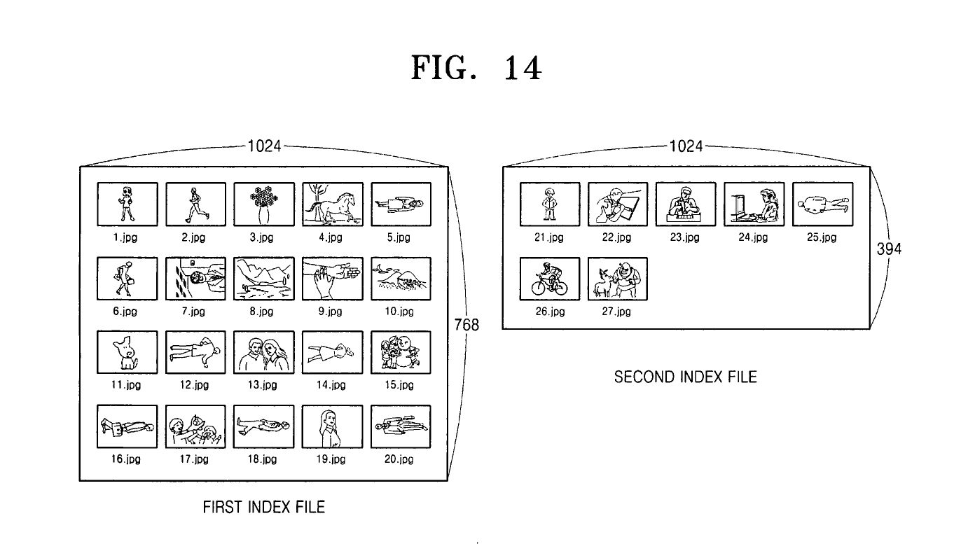

Referring to the example illustrated in FIG. 14, 27 image files are currently attached. Thus, a first index file is generated so as to include the standard number (i.e., 20) of index images, and a second index file is generated so as to include the remaining number (i.e., 7) of index images. With regard to the second index file, since the remaining number of index images is smaller than the standard number, the size of index file is changed according to the remaining index images. Accordingly, the second index file is generated to have a size of 1024*394, and the first index file is generated to have a size of 1024*768.

Referring back to FIG. 12, when the number of image files that are currently attached is not smaller or greater than the standard number, that is, when the number of image files are the same as the standard number, an index file including all index images of attached image files is generated (operation S26).

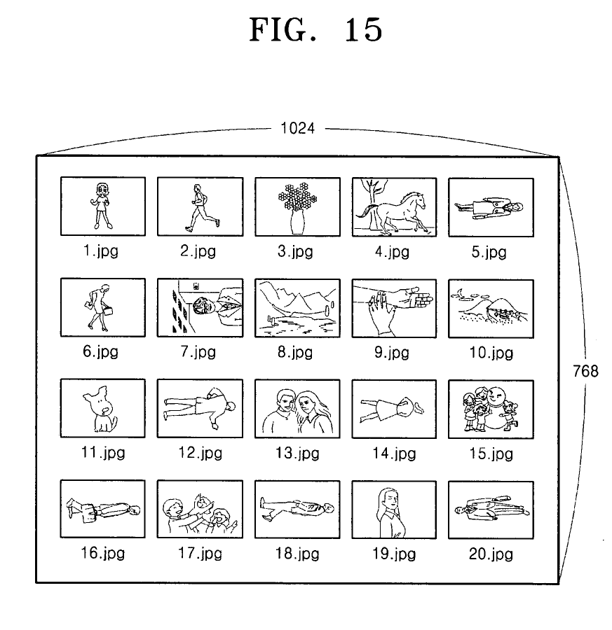

Referring to the example illustrated in FIG. 15, 20 image files are attached, and an index file including all index images of the image files is generated. Thus, the index file may have a size of 1024*768. According to the current embodiment, by changing the size of index file according to the number of attached image file, the size of transferred data or downloaded data can be reduced, thereby effectively transferring an e-mail.

In the current embodiment, the size of index file is adjusted by changing the number of image files, but the present invention is not limited thereto. That is, an index image and a filename may be generated from an image file to be stored such that the size of index file can be determined according to the size of the stored index image and file name.

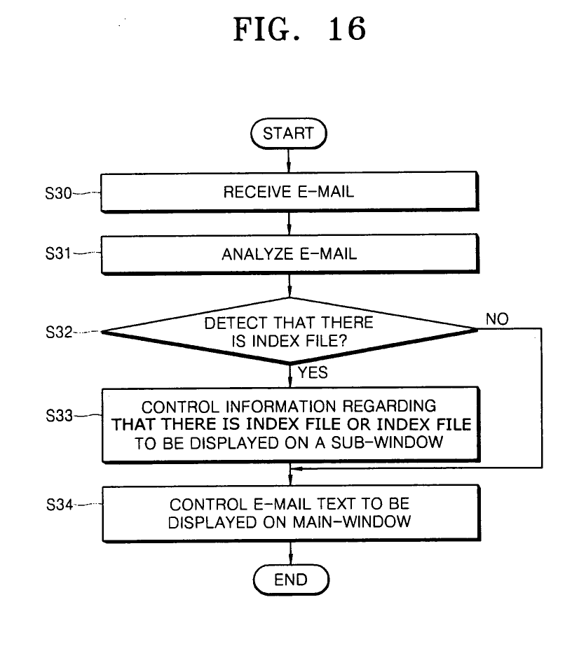

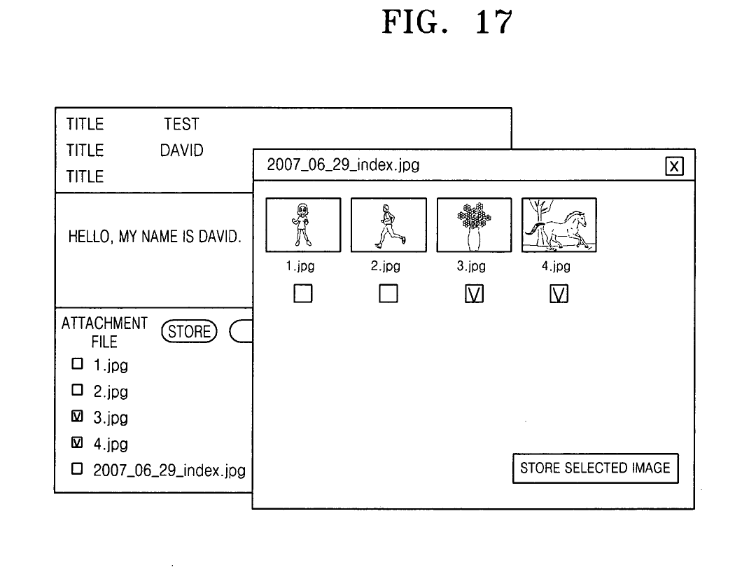

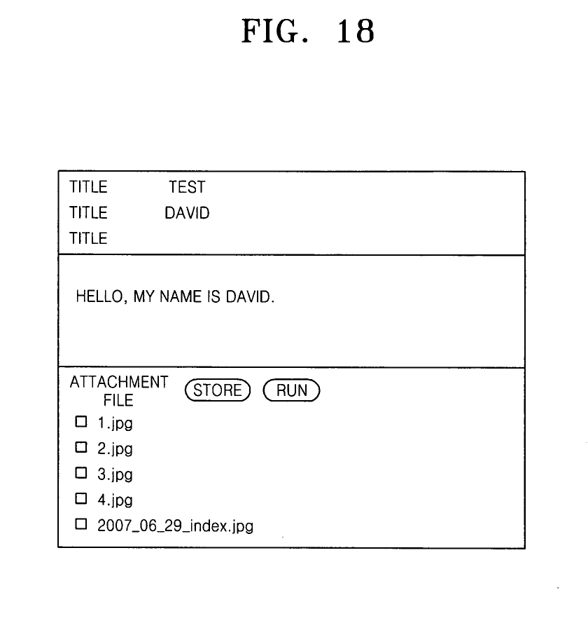

FIG. 16 is a flowchart illustrating an example of an operation of detecting and displaying an index file, which is performed in a method of communicating an e-mail according to another embodiment of the present invention. In the current embodiment, when a e-mail receiving terminal receives an e-mail, an operation of checking the index file is illustrated. Also, the operation according to the current embodiment will be described with reference to FIGS. 16 and 17, for convenience of description.

In particular, referring to the example illustrated in FIG. 16, an e-mail is received (operation S30).

The e-mail is analyzed (operation S31).

It is determined whether an index file is detected in the e-mail (operation S32).

In the current embodiment, the e-mail includes the index file, and thus information regarding that there is the index file is controlled to be displayed, or the index file is controlled to be automatically opened and then to be displayed on a sub-window (operation S33).

In addition, an e-mail text may be controlled to be displayed on a main-window (operation S34).

The order of the displaying of the index file or e-mail text on the main-window or sub-window may be reversed. Thus, the present invention is not limited thereto.

The controlling of the displaying may be performed by an e-mail server, preferably, an e-mail receiving terminal.

FIG. 17 illustrates examples of screens in which it is automatically detected that the e-mail includes the index file and the index file is automatically opened to be displayed on a sub-window, according to an embodiment invention.

In particular, referring to the example of FIG. 17, it is detected that the e-mail includes the index file, an e-mail text is displayed on a main-window, and the index file is automatically opened to be displayed on the sub-window. Then, after index images that are displayed on the sub-window are checked, boxes below the index images are marked with V so as to selectively download desired image files.

In the current embodiment, it is automatically detected that the e-mail includes the index file. In this case, this is informed to a recipient, or alternatively, the index file is automatically opened to be easily checked by a recipient. Furthermore, any desired image files may be selectively stored via the index images that are displayed on the sub-window.

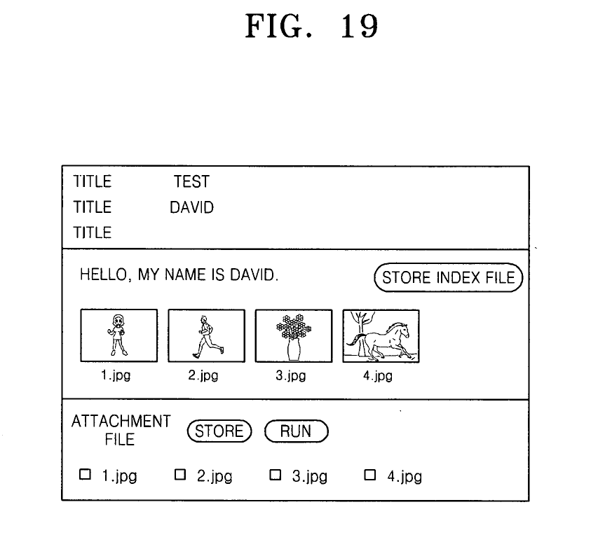

FIGS. 18 and 19 illustrate examples of screens on which an e-mail that is received in an e-mail receiving terminal is displayed, according to embodiments of the present invention.

The screen of FIG. 18 includes filenames of four image files and an index filename on a blank attachment of the e-mail. When the index filename written on the blank attachment is selected, the index image can be opened so as to be checked.

As another example, referring to FIG. 19, when the index file is inserted into an e-mail text, the index file together with the e-mail text can be checked.

Accordingly, attached image files can be easily checked.

As described above, in the method of communicating an e-mail and the system using the method, although image files having a relatively large size are not all opened, it is easy to check attached image files only from index files including a thumbnail image having a relatively small size, and thus image files can be selectively downloaded.

While the present invention has been particularly shown and described with reference to exemplary embodiments thereof, it will be understood by one of ordinary skill in the art that various changes in form and details may be made therein without departing from the spirit and scope of the present invention as defined by the following claims.

What is claimed is:

1. A method of communicating an e-mail, the method comprising:
selecting at least one image file;
generating an index file including an index image of the at least one image file; and
generating an e-mail including the at least one image file and the index file.

2. The method of claim 1, wherein a size of an original image of the at least one image file is reduced so as to generate an index image.

3. The method of claim 1, wherein a thumbnail image of the image file is extracted so that the thumbnail image is used as an index image.

4. The method of claim 1, wherein the at least one image file is a moving picture file including a plurality of frame images.

5. The method of claim 4, wherein an index image is generated from any one selected from among the plurality of frame images.

6. The method of claim 1, wherein a size of the index file is adjusted according to the number of the image files that are attached.

7. The method of claim 1, wherein the e-mail is generated by attaching the index file to the e-mail or inserting the index file into an e-mail text.

8. The method of claim 1, further comprising detecting that the e-mail includes the index file.

9. The method of claim 8, further comprising displaying the index file when it is detected that the e-mail includes the index file.

10. The method of claim 9, wherein the e-mail text is displayed on a main-window, and the index file is displayed on a sub-window.

11. An e-mail communication apparatus comprising:
an index file generating unit generating an index file from at least one selected image file; and
an e-mail generating unit generating an e-mail including the index file.

12. The apparatus of claim 11, wherein the index file generating unit comprises an index image generating unit generating an index image by reducing a size of an original image of the image file or generating the index image by using a thumbnail image of the image file as the index image.

13. The apparatus of claim 12, wherein when the image file is a moving picture file comprising a plurality of frame images,
the index image generating unit generates an index image by reducing a size of any one frame image selected from among the plurality of frame images or generating the index image by using a thumbnail image of the moving picture file as the index image.

14. The apparatus of claim 12, wherein the index file generating unit comprises a filename combining unit combining the index image with a filename of a corresponding image file.

15. The apparatus of claim 12, wherein the index file generating unit comprises a size adjusting unit adjusting a size of an index file according to the number of attached image files.

16. The apparatus of claim 11, wherein the e-mail generating unit generates an e-mail by attaching the index file or inserting the index file into an e-mail text.

17. The apparatus of claim 11, further comprising an index file detection unit detecting that the e-mail includes the index file.

18. The apparatus of claim 17, further comprising a display controlling unit controlling the index file detected by the index file detection unit to be displayed in an e-mail receiving terminal.

19. The apparatus of claim 11, wherein the e-mail communication apparatus comprises:
an e-mail server writing an e-mail including the image file and the index file;
an e-mail transmitting terminal transmitting the e-mail; and
an e-mail receiving terminal receiving the e-mail.

20. The apparatus of claim 19, wherein the e-mail transmitting terminal comprises the index file generating unit.

21. The apparatus of claim 19, wherein the e-mail server comprises the index file generating unit.
